(19) United States
(12) Patent Application Publication
(10) Pub. No.: US 2006/0165984 A1
(43) Pub. Date: Jul. 27, 2006

(54) Method of producing 3-d photonic crystal fibers

(76) Inventors: Hernan Miguez, Valencia (ES); Geoffrey Alan Ozin, Toronto (CA); San Ming Yang, Toronto (CA); Nicolas Tetreault, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 10/535,944

(22) PCT Filed: Dec. 16, 2003
(86) PCT No.: PCT/CA03/01949

§ 371 Date: Sep. 8, 2005

Related U.S. Application Data
(60) Provisional application No. 60/433,596, filed on Dec. 16, 2002.

(51) Int. Cl. B05D 1/40

(52) U.S. Cl. 428/375; 427/212; 427/162; 427/331; 427/248.1

(57) ABSTRACT

The invention described herein is broadly directed to 3D photonic crystal fibers exemplified but not limited to novel 3D inverse colloidal crystal fibers made of silicon. In particular the invention relates to the general utilization of controlled size and controlled shape and controlled length microchannel surface relief patterns that have been lithographically defined in silicon substrates for the geometrically confined crystallization of silica microspheres to form highly ordered and oriented colloidal photonic crystal microchannel templates and the utilization of such templates for creating, through silicon infiltration synthetic strategies, colloidal silicon-silica photonic crystal composite materials thereof and the subsequent removal of the silica template and detachment of these colloidal silicon-silica photonic crystal composite materials from the silicon substrate by etching in a fluoride-based medium to create oriented free standing 3D inverse colloidal photonic crystal fibers. These novel fiber constructs provide a new class of optical components with a complete PBG along transverse and longitudinal directions of the microfiber axis that can be tailored to lie in the optical telecommunication wavelength range. The synthetic strategy described herein provides a versatile means for making 3D colloidal photonic crystal optical fibers with a range of cross-sectional shapes and sizes, fiber lengths, elemental compositions and photonic lattice dimensions, refractive index contrasts and optical properties and with either normal or inverse colloidal lattice structures.

### FIELD OF THE INVENTION

The present invention relates to a method of producing photonic crystal fibers. More particularly, the present invention is exemplified by, but not limited to, 3D colloidal photonic crystal fibers useful as new optical components that are useful in the general field of fiber optics for optical telecommunication and optical sensing.

### BACKGROUND OF THE INVENTION

High optical quality, low light loss optical fiber waveguides emerged in the seventies. These optical components enabled the optical telecommunication revolution and facilitated a new generation of fiber optical sensors. A major development in the late eighties was the fiber Bragg grating in which a spatially periodic modulation is imposed on the refractive index of the core of a single mode fiber using a simple photochemical interference technique. This intrinsic microstructure gives the fiber the ability to reflect light of essentially one wavelength while permitting the passage of other wavelengths.

A typical optical fiber waveguide comprises a cylindrical glass core surrounded by a cladding of lower refractive index glass, the diameter of the latter being around 125 microns and the core lies in the range 3-50 microns. The light guiding properties of the core of this kind of optical fiber is founded upon total internal reflection of the light beam at the boundary between the core and cladding. At angles of incidence of the light beam larger than the critical angle, the boundary functions as a mirror and continually reflects and confines all of the light to the core. Single mode optical fibers can be made by reducing the diameter of the core or the difference between the refractive index of the cladding and core. These single mode optical fibers are used for optical telecommunication over long distances and at high speed.

A new generation of optical fibers emerged in the nineties known as photonic crystal fibers. (An excellent historical perspective of conventional solid core optical fibers as well as solid and hollow core photonic crystal fibers together with a compilation of key references in this field is given in Temelkuran et al Nature 2002, 420, 650-653). These microstructured fibers are based on 1D and 2D constructs, the former being described as a periodic dielectric based on a co-axial, microlaminate architecture while the latter comprises a micropaffern of air holes. Both of these microstructures can traverse the entire length of the fiber. The 1D photonic crystal fibers are of two classes, one with a solid core and the other with a hollow core, are usually structured in the form of a polymer-inorganic multilayer and display a 1D photonic band gap in a direction orthogonal to the axis of the fiber with a corresponding high reflection efficiency in that direction making these new fibers potentially useful as filters and mirrors as well as high capacity light and laser transmission for optical telecommunication. In the 2D photonic crystal fibers there are two main categories of microstructure. One type has a high index solid core and the other a low index air core, both types being surrounded by a regular micropattern of air holes. The former guides light by total internal reflection in the core whereas the latter guides light by core confinement due to the existence of a 2D photonic band gap. These air core fibers can be designed to be single mode over an unlimited wavelength range and are rather insensitive to bend light losses. Strong non-linear optical effects can be induced in the microfibers with air cores because of the confinement of the optical field to the small region of the air core. These 2D photonic crystal fibers may find utility for high capacity transmission of light and switching and shaping of light pulses.

Recent experimental and theoretical developments have shown that oriented colloidal photonic crystals offer opportunities for the fabrication of optical components, such as microlasers, waveguides, and superprisms. Thus, if 3D photonic crystal fibers exemplified but not limited to free standing colloidal photonic crystal fibers could be made this might enable the realization of these kinds of optical devices as well as optical couplers and optical interconnectors for routing light into, and out of, photonic crystal devices. Furthermore any photonic crystal phenomenon in such 3D photonic crystal fibers may be enhanced relative to the 1D and 2D versions mentioned above and any device based on them might be easily integrated into microphotonic technology.

### SUMMARY OF THE INVENTION

It is an object of the present invention to provide a straightforward synthetic strategy for making 3D photonic crystal fibers exemplified but not limited to 3D colloidal photonic crystal fibers. Specifically, an object of this invention is to provide a simple, fast and versatile means for making 3D photonic crystal fibers with a range of cross-sectional shapes and sizes, fiber lengths, elemental compositions and photonic lattice dimensions, refractive index contrasts and optical properties.

The preparative method exemplified and utilized in this invention is founded upon the formation of a 3D oriented silicon-silica colloidal photonic crystal composite material exclusively within geometrically and spatially well defined microchannel surface relief patterns in a silicon substrate by a directed self-assembly strategy followed by removal of silica from the composite and from the surface of the silicon substrate to provide 3D silicon colloidal photonic crystal fibers with an oriented photonic crystal lattice and in a free-standing form.

In one aspect of the invention there is provided a method of making 3D photonic crystal fibers, comprising the steps of;

a) forming a colloidal crystal by crystallizing microparticles made of a first pre-selected material within spatial confines of micrometer scale elongate surface features formed in a surface of a substrate;

b) depositing a coating of a second pre-selected material of known thickness on the microparticles to control connectivity between adjacent microparticles; and

c) etching away the second pre-selected material to free the colloidal crystal of the second pre-selected material that holds it in the elongate surface features on the substrate resulting in the formation of a free-standing 3D colloidal photonic crystal fiber.

In this aspect of the invention there may be included a step of infiltrating a third pre-selected material having a pre-selected refractive index into the elongate surface features after step b) for coating the crystallized microparticles layer by layer with the third pre-selected material until a pre-selected fraction of interstitial spaces of the colloidal crystal is filled with the third pre-selected material, and wherein step c) includes etching away the colloidal crystal and the second pre-selected material to simultaneously produce an inverted colloidal crystal formed of the third pre-selected material and to free the inverted colloidal crystal of the second pre-selected material that holds it in the elongate surface features on the substrate resulting in the formation of a free-standing 3D inverted colloidal photonic crystal fiber made of the third pre-selected material.

In another aspect of the invention there is provided a method of making 3D photonic crystal fibers, comprising the steps of;

forming a colloidal crystal by crystallizing microparticles made of a first pre-selected material within spatial confines of micrometer scale elongate surface features formed in a surface of a substrate;

depositing a coating of silica of known thickness on the microparticles to control connectivity between adjacent microparticles;

infiltrating silicon into the elongate surface features for coating the crystallized microparticies layer by layer with silicon until a selected volume-filling fraction of silicon in tetrahedral and octahedral interstitial spaces of the silica colloidal crystal is filled with silicon; and

etching the colloidal crystal and the silica on the surface of the substrate to simultaneously free the silicon inverse colloidal crystal of the silica that fills its lattice spaces and to remove the silica that holds it in the elongate surface features on the substrate resulting in the formation of a free-standing 3D silicon inverted colloidal photonic crystal fiber.

In another aspect of the invention there is provided a photonic crystal fiber produced according to a method comprising the steps of;

forming a colloidal crystal by crystallizing microparticles made of a first pre-selected material within spatial confines of micrometer scale elongate surface features formed in a surface of a substrate;

depositing a coating of a second pre-selected material of known thickness on the microparticles to control connectivity between adjacent microparticles;

infiltrating a third pre-selected material having a pre-selected refractive index into the elongate surface features for coating the crystallized microparticles layer by layer with the third pre-selected material until a pre-selected fraction of tetrahedral and octahedral interstitial spaces of the colloidal crystal is filled with the third pre-selected material; and

etching away the colloidal crystal and the second pre-selected material on the surface of the substrate to simultaneously produce an inverted colloidal crystal formed of the third pre-selected material and to free the inverse colloidal crystal of the second pre-selected material that holds it onto the substrate resulting in the formation of a free-standing 3D inverted colloidal photonic crystal fiber made of the third pre-selected material.

Such photonic crystal fiber constructs provide a new class of optical components with a complete PBG along transverse and longitudinal directions of the fiber and that can be tailored to lie in the optical telecommunication wavelength range. 3D colloidal photonic crystal fibers produced in accordance with the present invention may be self-assembled into a range of optically functional devices, exemplified but not limited to optical couplers and optical interconnects in optical circuits. The microoptical spectroscopy of these fibers is consistent with the existence of a complete PBG near 1.5 microns making them interesting as optical components of envisioned all-optical microphotonic crystal circuits, chips and computers.

### BRIEF DESCRIPTION OF THE DRAWINGS

The methods of making 3D photonic crystal fibers exemplified but not limited to oriented free standing 3D colloidal photonic crystal fibers according to the present invention will now be described, by way of example only, reference being made to the accompanying drawings:

FIG. 1 SEM micrographs of: (a) Rectangular colloidal crystal microchannel. The long range order of the external surface can be seen; (b) Detail of a cleaved edge of a colloidal crystal microchannel with a thickness of 8 close packed microsphere layers; (c) Detail of the external [111] surface of the colloidal crystal channel after a layer by layer growth of silica is performed by chemical vapor deposition (CVD). This treatment enhances the mechanical stability of the silica template and allows control of the degree of interpenetration of the particles; (d) Detail of a cross section of the microchannel after silica deposition by CVD.

FIG. 2 shows scanning electron micrographs (SEM) micrographs of an inverted silicon colloidal photonic crystal fiber: (a) Low magnification image of the bottom surface, observable after the lift off from the substrate; (b) and (c) Details of the top surface of the same kind of fibers, showing that maximum silicon infiltration was achieved (closure of external pores); (d) and (e) Details of the bottom surface of a free standing silicon inverted colloidal photonic crystal fiber, showing the high degree of connectivity and uniformity between the spherical cavities resulting from the SiO₂ CVD treatment of the silica colloidal crystal microchannel template, which also allows removal of the fibers from the substrate.

FIG. 3 shows micrographs of a collection of different free standing inverted silicon colloidal photonic crystal rectangular-shaped fibers: (a) Low magnification SEM image of a bunch of fibers collected using a sticky carbon tape; (b) Optical picture of two fibers presenting a different degree of infiltration and therefore displaying different colors; (c) Closer look by SEM of a slightly tilted fiber, showing explicitly the rectangular-shape.

FIG. 4 Left: Photonic band structure of a face centered cubic arrangement of overlapping spherical cavities coated by silicon shells. For the calculation we consider a refractive index of silicon of 3.5 and an inner and outer diameter of the silicon shells of 1.02φ and 1.1547φ respectively, where φ is the spherical cavity center-to-center distance, which is the same as the diameter of the spheres in the original template. The frequencies are plotted in units of φ/λ, λ being the wavelength of light. All the stop bands in the Γ-L direction, which are experimentally accessible, are shadowed. The full photonic band gap is also shown along several principal directions of the-first Brillouin zone. Right: Reflectance of a free standing inverted silicon colloidal crystal fiber obtained from a template made of φ=870 nm diameter spheres, prior to CVD infiltration of silica. The number and the position of the maxima detected are in good agreement with the calculation. A comparison between theory and experiment indicates that the absolute maximum observed at φ/λ=0.635 in the spectrum (λ≈1.4 μm) should correspond to the full photonic gap. The oscillations observed for frequencies below φ/λ=0.3 are due to the finite size of the silicon inverted colloial photonic crystal fiber along the (111) direction.

FIG. 5(a) Top view of a triangular silicon inverted colloidal photonic crystal fiber confined within a silicon wafer. The 70° angle between the walls of the etched V-shaped groove which hosts the colloidal crystal determines its orientation to be [001] in the direction perpendicular to the wafer, as can be clearly seen in the picture. (b) Detail of a cleaved edge of the same fiber as seen from the top, showing explicitly the stacking of (001) planes. (c) Low magnification micrograph of a cleaved edge of a silicon wafer containing an array of oriented silicon inverted colloidal photonic crystal fibers. (d) Cross section showing the [110] crystallographic direction parallel to the groove. (e) and (f) Free standing silicon inverted colloidal photonic crystal triangular-shaped fiber showing the {111} planes (namely, (−111) and (11-1)) previously in contact with the walls of the groove.

### DETAILED DESCRIPTION OF INVENTION

In this detailed description of the invention, we provide two examples of a novel strategy for synthesizing 3D photonic crystal fibers exemplified but not limited to inverse silicon colloidal photonic crystal fibers that are oriented and free standing and have different cross sectional shapes. This new class of optical fiber exhibits a complete photonic band gap in the optical telecommunication wavelength range around 1.5 microns and may offer advantages and new uses with respect to their 1D and 2D photonic crystal fiber versions.

To put the synthetic method in perspective it is noted that the fabrication of 3D photonic crystals based on colloidal crystal templating represents one of the most attractive approaches among those currently being considered to overcome the challenge of building up a 3D periodic modulation of refractive index at the micrometer length scale. Important advances have been made by using micrometer size silica or latex sphere colloidal crystals, which can also be used as templates to impose a 3D order to different materials. Briefly, colloidal crystals can be built from a suspension of microspheres either by sedimentation on a flat substrate, which gives rise to large size face centred cubic (fcc) crystals, or by convection force induced self-assembly of microspheres on a flat substrate, which results in planarized fcc crystals of controlled thickness, or by infiltration and later crystallization of microspheres in surface relief patterns, which results in confined fcc crystals of controlled thickness and orientation. Details of some of the methods employed in the work described herein may be found in copending U.S. patent application Ser. No. 09/977,254 filed Oct. 16, 2001, which is incorporated herein by reference in its entirety.

Once the colloidal crystal has been formed in the surface relief pattern, the method disclosed herein may be used for making 3D photonic crystal fibers which are free standing normal or inverted colloidal photonic crystal fibers through the use of a controlled size and controlled shape and controlled length of the microchannel surface relief pattern that has been produced in the surface of a planar substrate. There are many methods of producing the elongate surface relief patterns, for example they may be lithographically defined. The use of the surface relief pattern in the first instance is for the confined crystallization of microparticles (preferably microspheres) to form a normal colloidal photonic crystal microchannel and detachment thereof from the substrate to which the normal colloidal photonic crystal microchannel was attached to generate free standing normal colloidal photonic crystal fibers.

In the second instance inverted colloidal photonic crystals are made wherein the normal colloidal photonic crystal after being produced is used as a template and the void spaces between the microspheres is filled with another material to form a colloidal photonic crystal microchannel composite material and the subsequent removal of the template from the composite material and detachment thereof from the substrate produces free standing inverted colloidal photonic crystal fibers. By infiltrating the interstitial sites of these colloidal crystal templates with different refractive index materials and later removal of the colloidal crystal scaffold, an inverted colloidal crystal structure consisting of interconnected air cavities in a certain dielectric constant medium is attained. This chemical approach to the fabrication of colloidal photonic crystals leads to optical quality materials with the desired geometry, topology and dielectric contrast.

With the above as background information, a straightforward means of making oriented, free standing silicon inverse colloidal photonic crystal fibers with either rectangular-shaped or V-shaped cross-sections is described in the following examples. To those skilled in the art it will be readily apparent that the examples given hereinafter are purely illustrative and non-limiting so that the present invention is not intended to be limited to silicon or inverted silicon colloidal photonic crystal structures but rather the principles disclosed herein are broadly applicable to normal as well as inverse colloidal photonic crystal structures with compositions other than silicon and cross sections other than rectangular-shapes and V-shapes (for example they could be hemispherical or square in cross section) and a range of lengths with a range of photonic lattice dimensions templated by different diameter colloidal crystal microspheres. The 3D optical fibers may be made on any substrate and the present method is not restricted to silicon substrates such as used in the examples below. The silicon may be deposited under conditions suitable to give for example amorphous, nanocrystalline, polycrystalline or single crystal silicon.

Similarly, the present method is not restricted to microspheres per se but may be more generally applied to microparticles which may be ellipsoidally- or rod-shaped just to mention a few possibilities. When using microspheres, the diameter may be between ˜150 nm and ˜3000 nm and preferably between about 200 nm and 3000 nm.

### EXAMPLE 1

Rectangular-Shaped Colloidal Photonic Crystal Fiber

Silica microspheres with a diameter between ˜150 nm and ˜3000 nm are first crystallized within the spatial confines of a parallel array of micrometer scale rectangular microchannels. The micro-channels were prepared by patterning a silica or silica-on-silicon flat substrate using the methodology of soft-lithography. Convection, capillary and gravitation forces cause the silica microspheres in an ethanolic dispersion to nucleate and grow as well-ordered and oriented face centered cubic (f.c.c.) colloidal crystals exclusively within the microchannels, with the top surface of the colloidal crystal being [111], the sidewalls [11-2] and the end surfaces [1-10]. In order to control the degree of connectivity between silica microspheres in the microchannel, a coating of silica of controlled thickness is deposited by chemical vapor deposition (CVD) and hydrolysis of silicon tetrachloride using the method disclosed in U.S. copending patent application Ser. No. 10/255,578 which is incorporated herein by reference in its entirety.

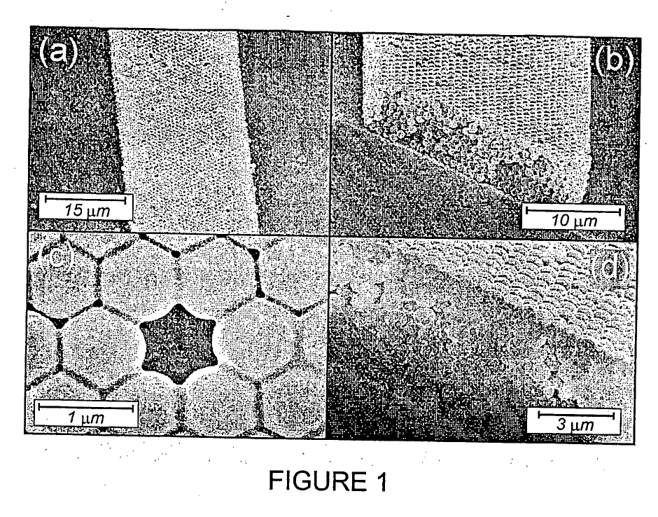

FIG. 1 shows scanning electron microscopy (SEM) images of a silica colloidal crystal rectangular-shaped microchannel template before, FIGS. 1a and 1b, and after, FIGS. 1c and 1d, the silica infiltration by CVD. Detailed SEM imaging demonstrates in particular the oriented growth of the colloidal crystal and the high degree of particle necking achieved by the silica CVD treatment can be clearly seen. It provides a high mechanical stability as determined by nanomechanical measurements and allows control of the filling fraction of the template.

These silica colloidal crystal microchannels are then infiltrated with silicon in a static chemical vapor deposition reactor using disilane precursor at a pressure of 100 Torr and a temperature of 300° C. The deposited silicon at this temperature forms in the amorphous state and uniformly coats the silica microspheres in a layer-by-layer growth process, which enables excellent control over the volume-filling fraction of silicon in the tetrahedral and octahedral interstitial spaces of the silica colloidal crystal. These process steps can be performed in a quantitative manner and prove to be pivotal for precise control of the photonic band gap properties of the desired oriented 3D silicon inverted colloidal photonic crystal fibers.

To obtain free-standing oriented 3D silicon inverted colloidal photonic crystal fibers from these parallel microchannel arrays of composite silica-silicon colloidal crystals all that is required is sacrificial etching of the silica colloidal crystal and the silica on the surface of the substrate using 1% HF/H2O. However it will be understood that this step of etching may employ any concentration of HF, for example another solution that may be used is 10% HF/12% HCl.

This process serves to simultaneously free the silicon inverse colloidal crystal microchannel of the silica that fills its lattice spaces and removes the silica that holds it onto the substrate resulting in the formation of a collection of free-standing 3D silicon inverted colloidal photonic crystal fibers. After washing and drying of the suspension, the fibers are collected on top of a carbon tape for further electron and optical microscopy analysis.

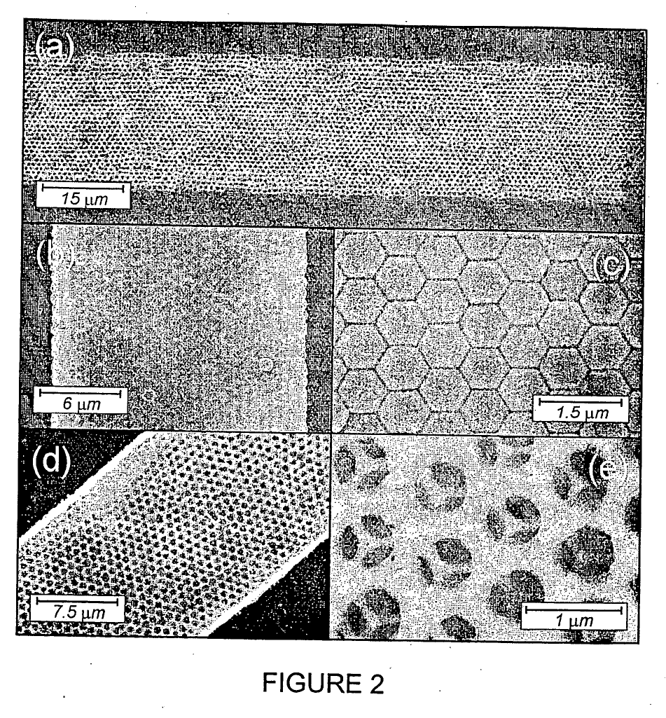

Representative SEM images of self-supporting rectangular-shaped fibers are depicted in FIG. 2(a) to and clearly show the structurally well-organized inverse silicon colloidal photonic lattice. Both the control over the dimensions of the photonic lattice and command of the orientation of the silicon inverted colloidal photonic crystal fibers results from geometric confinement of silica colloidal crystallization within soft-lithographically pre-defined surface relief micro-channel patterns in the substrate. Long-range order is observed in the external surfaces of the fibers (see FIG. 2(a), corresponding to a bottom surface of the fiber). Since the silicon growth process takes place layer-by-layer, the infiltration stops when the external pores of the template are closed (FIGS. 2(b) and (c)) and before a complete filling of the interstitial space is achieved. The morphology of the bottom surface (FIGS. 2(b) and (c)), arising from the fact that it is in contact with the substrate, permits to observe the large interconnecting circular windows between spherical cavities, a result of the necking of the starting silica microspheres by silica CVD coating.

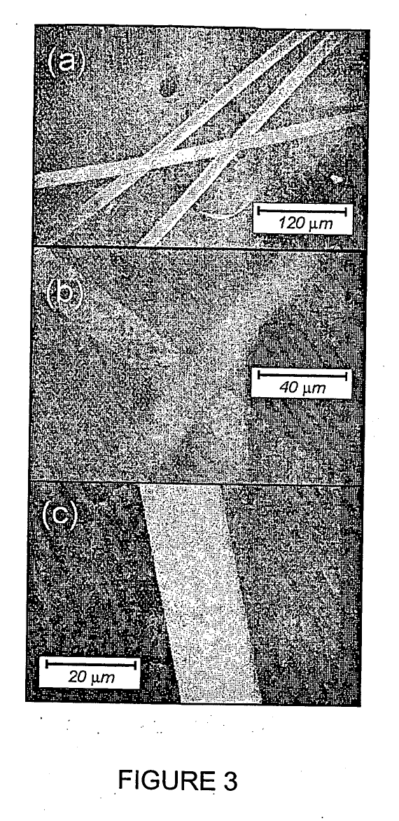

FIG. 3 shows low magnification microscope images of a collection of fibers presenting different degrees of infiltration. Their length can be of several hundreds of microns (FIG. 3(a)). When observed under the optical microscope using a white light source, they display their characteristic reflected colors resulting from the modulation of dielectric constant in the structure. Different degrees of silicon infiltration in the fiber give rise to different colors (FIG. 3(b)) and the rectangular-shape can be can be clearly seen in the SEM image of a slightly tilted fiber (FIG. 3(c)).

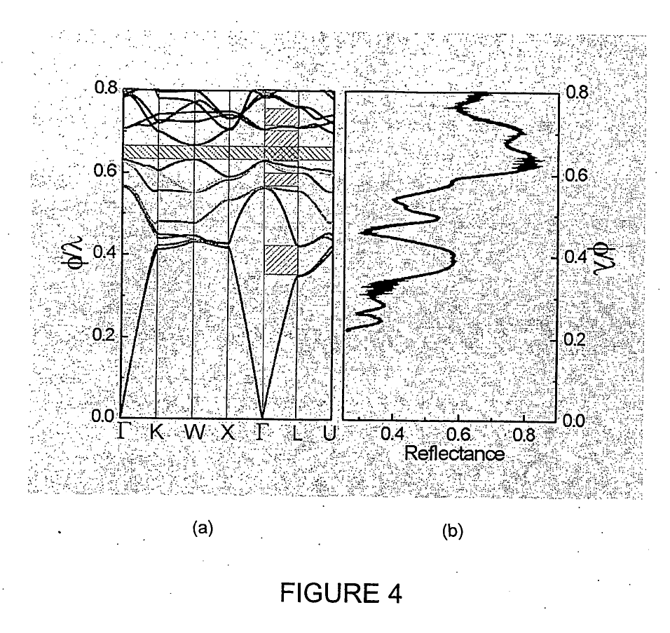

The accessibility of the well-defined [111] crystal face of the rectangular-shaped inverted silicon colloidal photonic crystal free-standing fibers, enables microoptical spectroscopy measurements to be recorded in a near IR Fourier transform instrument with the incident light source spanning an angle between 15° and 35° with respect to the [111] crystallographic direction of the optical lattice. A typical reflectance spectrum so obtained for the fibers is shown in FIG. 4(b) together with the calculated photonic band gap diagrams (FIG. 4(a)) along several principal directions in the first Brillouin zone for a f.c.c. lattice of overlapping spherical cavities coated by silicon shells.

More particularly, FIG. 4(a) shows the photonic band structure of a face centered cubic arrangement of overlapping spherical cavities coated by silicon shells. For the calculation we consider a refractive index of silicon of 3.5 and an inner and outer diameter of the silicon shells of 1.02φ and 1.1547φ respectively, where φ is the spherical cavity center-to-center distance, which is the same as the diameter of the spheres in the original template. The frequencies are plotted in units of φ/λ, λ being the wavelength of light. All the stop bands in the Γ-L direction, which are experimentally accessible, are shadowed. The full photonic band gap is also shown along several principal directions of the first Briflouin zone. Right: Reflectance of a free standing inverted silicon colloidal crystal fiber obtained from a template made of φ=870 nm diameter spheres, prior to CVD infiltration of silica. The number and the position of the maxima detected are in good agreement with the calculation. A comparison between theory and experiment indicates that the absolute maximum observed at φ/λ=0.635 in the spectrum (λ≈1.4 μm) should correspond to the full photonic gap. The oscillations observed for frequencies below φ/λ=0.3 are due to the finite size of the silicon inverted colloidal photonic crystal fiber along the (111) direction.

It is believed that maximum infiltration was achieved, as indicated by SEM results. Inspection of the results shows there is good agreement between the observed and computed silicon fiber stop bands and photonic band gap, the latter being around 1.4 microns and corresponding to the primary maximum in the spectrum.

### EXAMPLE 2

V-Shaped Colloidal Photonic Crystal Fiber

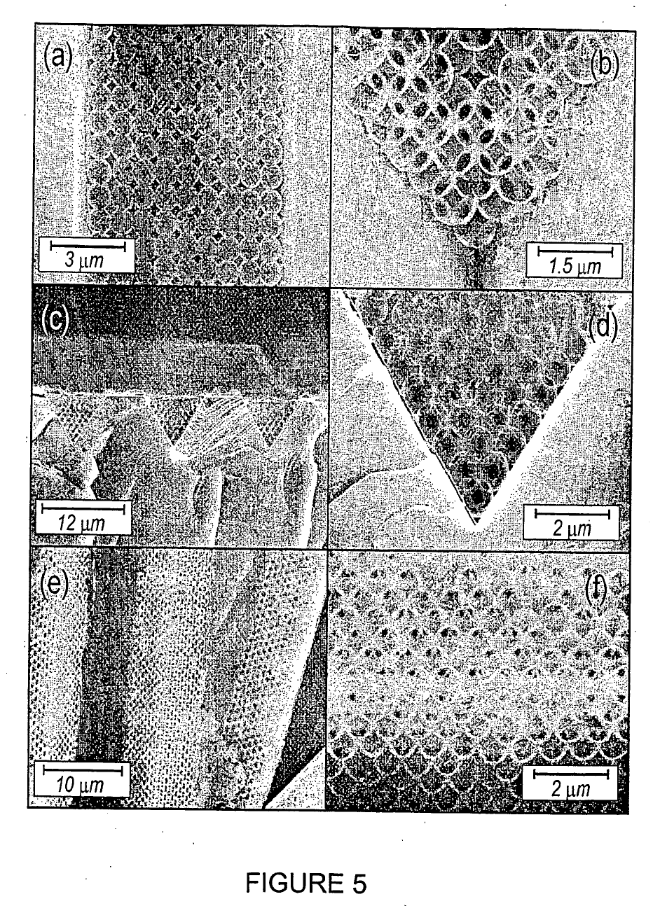

Using a similar procedure to that described in Example 1 but instead utilizing V-shaped silica colloidal crystal microchannel templates it is possible to make free standing oriented inverted silicon colloidal photonic crystal V-shaped fibers. V-shape surface relief patterns were prepared by microcontact printing followed by anisotropic etching of silicon wafers. Colloidal crystallization inside the microchannels was achieved by letting a drop of a suspension of microspheres to infiltrate into them by capillary forces. A similar silicon infiltration and template etching process to that described for rectangular-shaped microchannels, was performed. The results are shown in FIGS. 5(a) to 5(f) in which FIG. 5(a) shows a top view of a triangular silicon inverted colloidal photonic crystal fiber confined within a silicon wafer. The 70° angle between the walls of the etched V-shaped groove which hosts the colloidal crystal determines its orientation to be [001] in the direction perpendicular to the wafer, as can be clearly seen in the picture. FIG. 5(b) shows the detail of a cleaved edge of the same fiber as seen from the top, showing explicitly the stacking of (001) planes. FIG. 5(c) is a low magnification micrograph of a cleaved edge of a silicon wafer containing an array of oriented silicon inverted colloidal photonic crystal fibers. FIG. 5(d) is a cross section showing the [110] crystallographic direction parallel to the groove. FIGS. 5(e) and 5(f) show free standing silicon inverted colloidal photonic crystal triangular-shaped fiber showing the {111} planes (namely, (−111) and (11-1)) previously in contact with the walls of the groove.

As expected for V-shaped template microchannels with an apex angle of 70.6°, the top surface of the V-shaped inverted silicon colloidal photonic crystal fiber is [001] (FIGS. 5(a) and (b)), the ends are [110] (FIGS. 5(c) and (d)) and the sidewalls belong to the {111} family of planes (FIGS. 5(e) and (f)). Because of the small dimensions of the V-shaped fiber faces and those of the rectangular-shaped fiber {112} and {110} faces there was difficulty in getting microoptical spectral data for these directions.

In summary, the present invention provides a method of making 3D photonic crystal fibers which are free standing normal or inverted colloidal photonic crystal fibers through the use of a controlled size and controlled shape and controlled length microchannel surface relief pattern that has been lithographically defined in a planar substrate. The use of the surface relief pattern in the first instance is for the confined crystallization of microparticles (preferably microspheres) to form a normal colloidal photonic crystal microchannel and detachment thereof from the substrate to which the normal colloidal photonic crystal microchannel was attached to generate free standing normal colloidal photonic crystal fibers. In the second instance inverted colloidal photonic crystals are made wherein the normal colloidal photonic crystal microchannel after being produced is used as a template and the void spaces between the microspheres is filled with another material to form a colloidal photonic crystal microchannel composite material and the subsequent removal of the template from the composite material and detachment thereof from the substrate produces free standing inverted colloidal photonic crystal fibers.

The optical fibers may then be used in optical components produced for example by bonding them to substrates which may be patterned, based on for example lithographically defined surface relief patterns or chemically modified surface patterns, and the optical fibers used to form optically functional microphotonic crystal devices including optical couplers, optical interconnects and optical circuits.

As used herein, the terms “comprises” and “comprising” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. A method of making 3D photonic crystal fibers, comprising the steps of;
a) forming a colloidal crystal by crystallizing microparticles made of a first pre-selected material within spatial confines of micrometer scale elongate surface features formed in a surface of a substrate;
b) depositing a coating of a second pre-selected material of known thickness on the microparticles to control connectivity between adjacent microparticles; and
c) etching away the second pre-selected material to free the colloidal crystal of the second pre-selected material that holds it in the elongate surface features on the substrate resulting in the formation of a free-standing 3D colloidal photonic crystal fiber.

2. The method according to claim 1 including infiltrating a third pre-selected material having a pre-selected refractive index into the elongate surface features after step b) for coating the crystallized microparticles layer by layer with the third pre-selected material until a pre-selected fraction of interstitial spaces of the colloidal crystal is filled with the third pre-selected material, and wherein step c) includes etching away the colloidal crystal and the second pre-selected material to simultaneously produce an inverted colloidal crystal formed of the third pre-selected material and to free the inverted colloidal crystal of the second pre-selected material that holds it in the elongate surface features on the substrate resulting in the formation of a free-standing 3D inverted colloidal photonic crystal fiber made of the third pre-selected material.

3. The method according to claim 2 wherein the pre-selected Refractive index of the third pre-selected material is selected such that the free-standing 3D inverted colloidal photonic crystal fiber has a complete photonic bandgap.

4. The method according to claim 2 wherein the first and second pre-selected materials are silica, and wherein the third pre-selected material is silicon so that the inverted colloidal photonic crystal is a silicon inverted colloidal photonic crystal.

5. The method according to claim 1 wherein the microparticles are microspheres.

6. The method according to claim 5 wherein the microspheres are silica microspheres.

7. The method according to claim 5 wherein the microspheres have a diameter between ˜150 nm and ˜3000 nm.

8. The method according to claim 1 wherein the elongate surface features formed in the surface of the substrate are longitudinal rectangular microchannels.

9. The method according to claim 1 wherein the elongate surface features formed in the surface of the substrate are longitudinal V-shaped microchannels.

10. The method according to claim 1 wherein the elongate surface features formed in the surface of the substrate are longitudinal hemispherical-shaped microchannels.

11. A method of making 3D photonic crystal fibers, comprising the steps of;
forming a colloidal crystal by crystallizing microparticles made of a first pre-selected material within spatial confines of micrometer scale elongate surface features formed in a surface of a substrate;
depositing a coating of silica of known thickness on the microparticles to control connectivity between adjacent microparticles;
infiltrating silicon into the elongate surface features for coating the crystallized microparticles layer by layer with silicon until a selected volume-filling fraction of silicon in tetrahedral and octahedral interstitial spaces of the silica colloidal crystal is filled with silicon; and
etching the colloidal crystal and the silica on the surface of the substrate to simultaneously free the silicon inverse colloidal crystal of the silica that fills its lattice spaces and to remove the silica that holds it in the elongate surface features on the substrate resulting in the formation of a free-standing 3D silicon inverted colloidal photonic crystal fiber.

12. The method according to claim 11 wherein the microparticles are microspheres having a diameter between ˜150 nm and ˜3000 nm.

13. The method according to claim 12 wherein the microspheres are silica microspheres.

14. The method of according to claim 11 wherein the silicon is infiltrated using disilane precursor at a pressure of about 100 Torr and a temperature of about 300° C. wherein the disilane undergoes reaction to silicon which coats the microparticles and fills interstitial spaces of the colloidal crystal.

15. The method of making 3D photonic crystal fibers according to claim 11 wherein the coating of silica of controlled thickness is deposited by chemical vapor deposition (CVD) and hydrolysis of silicon tetrachloride.

16. The method of making 3D photonic crystal fibers according to claim 11 wherein the step of etching of the colloidal crystal and the silica includes using an HF containing solution as an etchant.

17. A photonic crystal fiber produced according to a method comprising the steps of;
forming a colloidal crystal by crystallizing microparticles made of a first pre-selected material within spatial confines of micrometer scale elongate surface features formed in a surface of a substrate;
depositing a coating of a second pre-selected material of known thickness on the microparticles to control connectivity between adjacent microparticles;
infiltrating a third pre-selected material having a pre-selected refractive index into the elongate surface features for coating the crystallized microparticles layer by layer with the third pre-selected material until a pre-selected fraction of tetrahedral and octahedral interstitial spaces of the colloidal crystal is filled with the third pre-selected material; and
etching away the colloidal crystal and the second pre-selected material on the surface of the substrate to simultaneously produce an inverted colloidal crystal formed of the third pre-selected material and to free the inverse colloidal crystal of the second pre-selected material that holds it onto the substrate resulting in the formation of a free-standing 3D inverted colloidal photonic crystal fiber made of the third pre-selected material.

18. The photonic crystal fiber produced according to claim 17 wherein the microparticles are microspheres.

19. The photonic crystal fiber produced according to claim 18 wherein the microspheres are silica microspheres.

20. The photonic crystal fiber produced according to claim 18 wherein the microspheres have a diameter between about 150 nm and about 3000 nm.

21. The photonic crystal fiber produced according to claim 17 wherein the first and second pre-selected materials are silica, and wherein the third pre-selected material is silicon so that the inverted colloidal photonic crystal is a silicon inverted colloidal photonic crystal.

22. The photonic crystal fiber produced according to claim 17 wherein the elongate surface features formed in the surface of the substrate are longitudinal rectangular microchannels.

23. The photonic crystal fiber produced according to claim 17 wherein the elongate surface features formed in the surface of the substrate are longitudinal V-shaped microchannels.

24. The photonic crystal fiber produced according to claim 17 wherein the elongate surface features formed in the surface of the substrate are longitudinal hemispherical-shaped microchannels.

25. The photonic crystal fiber produced according to claim 17 wherein photonic crystal fiber has a face centered cubic colloidal photonic lattice.

26. The photonic crystal fiber produced according to claim 17 wherein photonic crystal fiber has an oriented photonic lattice.

27. The photonic crystal fiber produced according to claim 17 wherein photonic crystal fiber has a cross section which is one of a V-shape, a square shape, a rectangular-shape and a hemispherical shape.

28. The photonic crystal fiber produced according to claim 21 wherein the silicon is deposited under conditions suitable to give one of amorphous, nanocrystalline, polycrystalline and single crystal silicon.

29. The photonic crystal fiber produced according to claim 17 wherein the third pre-selected material is selected from the group consisting of metals, semimetals, superconductors, semiconductors, insulators, organic and inorganic and organometallic polymers.

30. The photonic crystal fiber produced according to claim 17 wherein the photonic crystal fiber has a photonic lattice based on a face centered cubic lattice of air microholes or a face centered lattice of microspheres with microhole or microsphere diameters in the range from about 0.1 to about 3 microns.

31. The photonic crystal fiber produced according to claim 21 wherein the photonic crystal fiber has a complete photonic band gap at a pre-selected optical telecommunication wavelength.

32. The photonic crystal fiber produced according to claim 31 wherein the pre-selected optical telecommunication wavelength is about 1.5 microns.

33. The photonic crystal fiber produced according to claim 17 wherein the dimensions of the photonic crystal fiber are determined by the dimensions of the micrometer scale elongate surface features patterned into the substrate.

34. The photonic crystal fiber produced according to claim 17 wherein the substrate photonic crystal fiber are bonded to a polymer substrate using organic, inorganic, polymeric or other adhesive or mixtures of adhesives before chemical etching of the silica substrate and template.

35. The method according to claim 4 wherein a network topology of the photonic crystal fiber is determined by controlled necking of the silica colloidal photonic crystal using a silica layer-by-layer chemical vapor deposition process for growth of the silica layer on the microparticles.

36. A method according to claim 2 wherein the microparticles are latex microspheres, and wherein the second pre-selected material is silica, and wherein a network topology of the photonic crystal fiber is determined by controlled thermal necking of the latex normal colloidal photonic crystal followed by a silica layer-by-layer chemical vapor deposition process, and wherein the third pre-selected material is silicon so that the inverted colloidal photonic crystal is a silicon inverted colloidal photonic crystal.
